(19) United States
(12) Patent Application Publication
(10) Pub. No.: US 2008/0191637 A1
(43) Pub. Date: Aug. 14, 2008

(54) Method and apparatus for controlling electrical lighting installations

(76) Inventor: Peter R. Pettler, Nevada City, CA (US)

Correspondence Address: LumEnergi;(c/o) The Law Office of Robert A. McLauchlan, Post Office Box 26780, Austin, TX, 78755, US

(21) Appl. No.: 10/949,168

(22) Filed: Sep. 24, 2004

(51) Int. Cl. H05B 41/16; H05B 41/00; H05B 37/00; H02J 3/14

(52) U.S. Cl. 315/250; 315/312; 315/316; 307/39

(57) ABSTRACT

A simple method and apparatus are described for controlling two or more electrical devices. An encoder receives an alternating current (AC) voltage waveform and converts the AC voltage waveform to a modified voltage waveform selected according to a control input. A decoder located near the electrical devices receives the modified voltage waveform and either energies or deenergizes each of the electrical devices, depending upon the modified voltage waveform. Energized electrical devices receive energy from the modified voltage waveform. The modified voltage waveform both selects electrical devices to be energized and provides power to the energized electrical devices.

### BACKGROUND OF THE INVENTION

1. Field of the Invention

The present invention relates generally to lighting control methods and, more particularly, to methods of reducing energy consumed by fluorescent lighting installations.

2. Description of Related Art

Chronic and acute energy shortages have been part of the national experience in the United States in recent years. Accordingly, government and consumer groups have focused on a need to respond constructively to shortages of, for example, electrical energy. In keeping with this trend, the State of California has instituted a set of regulations, known as Title 24, which mandate energy saving measures in new construction. Title 24 applies to both commercial and residential buildings and includes provisions for bilevel lighting control.

Incorporating bilevel lighting control into existing buildings as well as into new construction could result in considerable savings of energy. Such incorporation tends not to be carried out in existing buildings, however, because of the expense and complication of retrofitting lighting systems with devices that use existing methods of bilevel lighting control. As a result, during periods of energy crisis, supermarkets, office buildings, manufacturing and other facilities, sometimes act to institute energy savings by literally carrying a step ladder around their installations and by disconnecting some fraction of fluorescent light tubes in order to save energy.

In addition to this rather crude, but direct, method of energy saving, more elaborate methods have been developed for controlling electrical loads and for removing some electrical devices from a circuit (referred to as “load shedding”). Load shedding methods may help to reduce energy consumption or to reduce power demand during periods of high energy consumption. Some load shedding techniques require installation of auxiliary wiring along side existing electrical wiring. Equipment using such techniques tends to be quite expensive and difficult to incorporate into existing facilities. Other load shedding methods may involve transmission of wireless signals to control remote devices in order to disconnect and reconnect electrical devices. Wireless transmission can be subject to unexpected reflections, distortion, and attenuation that may limit its effectiveness in load shedding applications. Alternatively, auxiliary radio or audio frequency signals may be directly transmitted over power lines to control load-shedding units. Such transmission of auxiliary signals may lead to reliability problems because of extremely noisy and unpredictable properties of power lines when used as a communication channel. Auxiliary signals also may be received in unintended areas. For example, a signal may propagate back through an electrical power distribution system and be received in a facility not related to the one in which load shedding is intended to occur. Additionally, radio-frequency devices may generate undesirable electromagnetic interference, and they tend to be expensive. They may be best incorporated into new installations where a load shedding capability is designed in initially and where power lines can be shielded to reduce electromagnetic interference.

A need thus exists in the prior art for an inexpensive method of performing load shedding that can be conveniently incorporated into an existing installation at low cost. A further need exists for load-shedding apparatus that is extremely reliable, that exhibits strong immunity to noise, and that does not generate electromagnetic interference.

### SUMMARY OF THE INVENTION

The present invention addresses these needs by providing a simple and reliable method and apparatus for controlling electrical devices in order to perform load shedding. The invention herein disclosed comprises a method of operating at least two electrical devices such as, for example, fluorescent tubes. According to an implementation of the method, a voltage waveform is received, the voltage waveform having a polarity signature. The polarity signature of the received voltage waveform may be detected, and at least one of the at least two electrical devices selected according to the detected polarity signature. The detecting may comprise recognizing a polarity signature chosen from a group consisting of a positive unipolar polarity signature, a negative unipolar polarity signature, and a bipolar polarity signature. The selected at least one electrical device may be energized using the received voltage waveform, while another at least one electrical device may be deenergized.

According to a representative variation of the method, a control input as well as an alternating current (AC) voltage waveform may be received. The AC voltage may be modified according to the control input, producing a voltage waveform having one of a positive unipolar polarity signature, a negative unipolar polarity signature, and a bipolar polarity signature. The receiving of a control input may comprise, for example, detecting a position of a signal responsive to a load-shedding command. In an another embodiment, the receiving of a control input further may comprise, as other examples, receiving a signal responsive to motion, to a change in time of day, to a presence of day lighting or to input strokes on an electronic keypad.

The present invention further comprises an apparatus for operating at least two electrical devices. An embodiment of the apparatus may comprise a receiving unit capable of receiving a voltage waveform having a polarity signature. This embodiment further may comprise a polarity discriminator capable of recognizing a polarity signature in the received voltage waveform and of generating a polarity signature indication according to the recognized polarity signature. According to another embodiment, the polarity discriminator may be capable of recognizing a polarity signature selected from a group consisting of a positive unipolar polarity signature, a negative unipolar polarity signature, and a bipolar polarity signature. Yet another embodiment of the present invention may comprise a selector capable of selecting at least one of the at least two electrical devices according to the polarity signature indication. The selector may cause the selected at least one electrical device to be energized using the voltage waveform.

Still another embodiment of the present invention comprises a load-shedding mechanism adaptable to electrical wiring supplying power to a plurality of electrical devices. An exemplary embodiment of the load-shedding mechanism comprises a decoder connected to the electrical wiring and adapted to receive a voltage waveform having a polarity signature. The decoder further may be adapted to generate a control signal according to the polarity signature, whereby the received voltage waveform energizes at least one of the plurality of electrical devices. At least one switch in this embodiment typically is adapted to deenergize at least one of the plurality of electrical devices according to the control signal.

While the apparatus and method has or will be described for the sake of grammatical fluidity with functional explanations, it is to be expressly understood that the claims, unless expressly formulated under 35 U.S.C. 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. 112 are to be accorded full statutory equivalents under 35 U.S.C. 112.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention are described herein. Of course, it is to be understood that not necessarily all such aspects, advantages or features will be embodied in any particular embodiment of the present invention. Additional advantages and aspects of the present invention are apparent in the following detailed description and claims that follow.

### BRIEF DESCRIPTION OF THE FIGURES

FIG. 1 is a flow diagram depicting an implementation of the method of the present invention;

FIG. 2 is a flow diagram illustrating a variation of a method of energizing or deenergizing at least one electrical device according to the present invention;

FIG. 3 is a block diagram of an embodiment of an apparatus capable of controlling the operation of a plurality of electrical devices in accordance with the present invention;

FIGS. 4 & 5 are block diagrams describing an illustrative embodiment of an apparatus capable of producing a voltage waveform having a polarity signature according to the present invention;

FIG. 6 is a schematic diagram of a prior art fluorescent lighting fixture;

FIG. 7 is a schematic diagram of an embodiment of an encoder/decoder structure controlling operation of a fluorescent lighting fixture according to the present invention;

FIG. 8A is a simplified schematic diagram of an embodiment of an encoder capable of producing a voltage waveform having a polarity signature in accord with the present invention;

FIG. 8B is a simplified schematic diagram of an another embodiment of an encoder capable of producing a voltage waveform having a polarity signature in accordance with the present invention;

FIG. 9 is a graphical representation of typical waveforms generated by the embodiments of the encoders illustrated in FIGS. 8A and 8B

FIG. 10 is a simplified schematic diagram of an embodiment of a decoder capable of selectively energizing two electrical devices according to the present invention;

FIG. 11 is a block diagram of another embodiment of a decoder capable of controlling the energizing of electrical devices according to the present invention; and

FIG. 12 is a simplified schematic diagram of an embodiment of signal conditioning circuitry included in FIG. 11.

### DETAILED DESCRIPTION

Reference will now be made in detail to embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the control of electrical lighting installations. The present invention may be practiced in conjunction with various electrical control techniques that are conventionally used in the art, and only so much of the commonly practiced process steps are included herein as are necessary to provide an understanding of the present invention. The present invention has applicability in the field of electrical power control in general. For illustrative purposes, however, the following description pertains to control devices and a method of conserving energy in lighting installations.

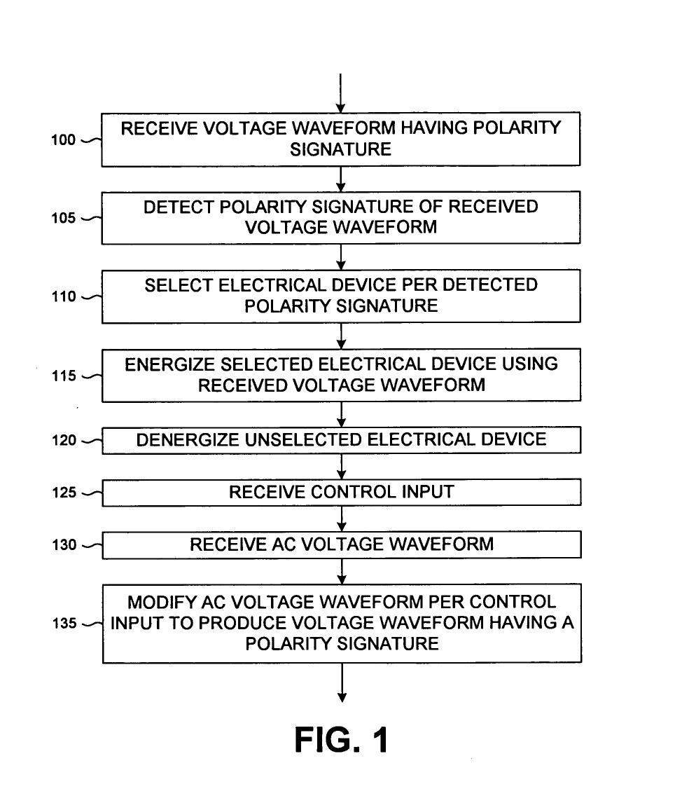

Referring more particularly to the drawings, FIG. 1 is a flow diagram depicting an implementation of the method of the present invention. According to this implementation, a voltage waveform having a polarity signature is received at step 100. In a representative embodiment, the voltage waveform may appear as a full-wave rectified pulsating direct current (DC) waveform having a positive polarity. Such a voltage waveform may be referred to as exhibiting a positive unipolar polarity signature. According to another example, a voltage waveform having a negative unipolar signature may be represented by a full-wave rectified pulsating DC waveform with negative polarity. An unmodified alternating current (AC) waveform may be described as having a bipolar polarity signature.

The polarity signature of the received voltage waveform is detected at step 105. According to the polarity signature detected, an electrical device may be selected at step 110. For example, the selected electrical device may be one of two electrical devices such as incandescent light bulbs, fluorescent tubes, or even separate filaments in a single incandescent light bulb. These types of non-inductive electrical devices may be particularly well suited to the present invention. The selected electrical device is energized at step 115 using the received voltage waveform. In particular, incandescent light bulbs and fluorescent tubes may be energized by a received voltage waveform having a polarity signature of the type already described. An electrical device not selected (i.e., an unselected electrical device) may be deenergized at step 120. The energizing and deenergizing of electrical devices may be controlled by one or more switches connected to the electrical devices and controlled according to the polarity signature of the received voltage waveform.

According to an aspect of the method of the present invention, a control input may be received at step 125. According to a typical embodiment, the control input may comprise, for example, a position of a multiposition mechanical switch. In another embodiment the control input may comprise at least one of receiving a signal responsive to motion, receiving a signal indicative of a change in time of day, receiving a signal indicative of a presence of day lighting, and receiving a signal from an electronic keypad. An AC voltage waveform of a type normally received from a power line or lighting panel may be received at step 130. The AC voltage waveform may be modified to produce a voltage waveform having a polarity signature according to the control input at step 135. For example, a control input may comprise a command to turn off an electrical device in order to conserve energy. Accordingly, the AC voltage waveform may be modified to produce, for example, a voltage waveform having a negative polarity signature that may be used to select an electrical device to be turned off.

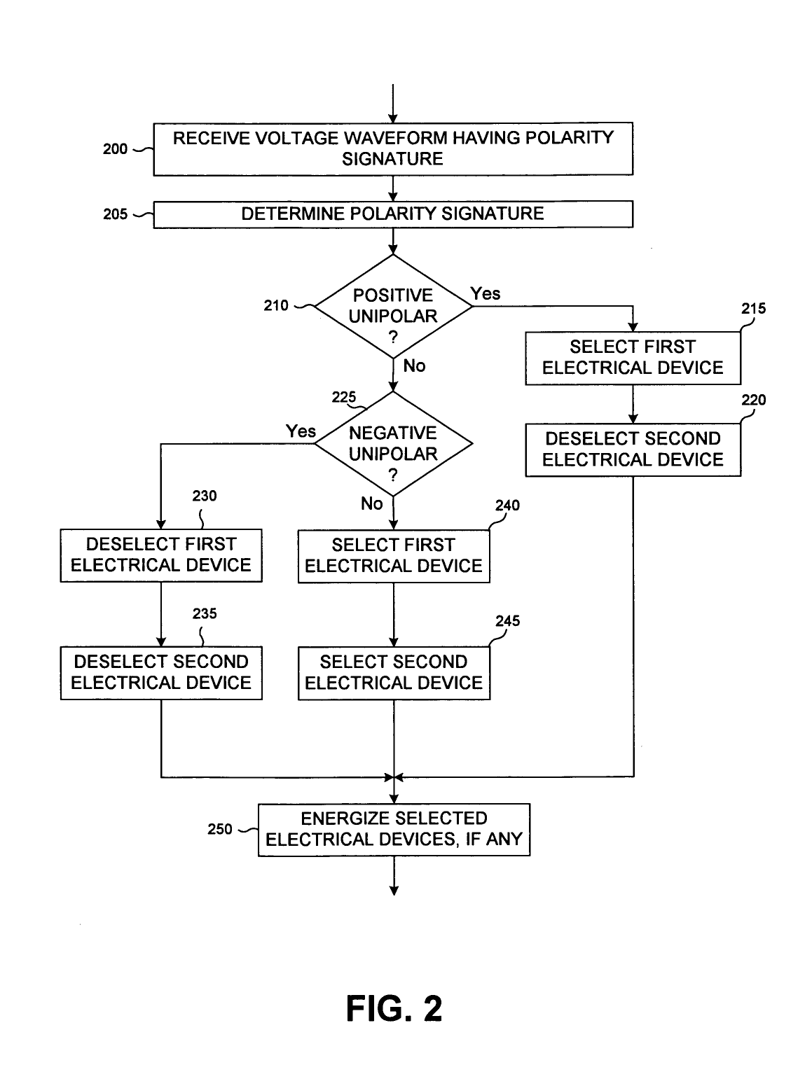

FIG. 2 is a flow diagram illustrating a variation of a method of selecting or deselecting (i.e. not selecting) at least one electrical load, such as a lighting device, according to the present invention. A voltage waveform having a polarity signature as already described is received at step 200. The received voltage waveform is analyzed, and the polarity signature of the received voltage waveform is determined at step 205. According to an illustrative implementation of the method, a test is performed at step 210 to determine whether the received voltage waveform has a positive unipolar polarity signature. If the received voltage waveform does have a positive unipolar polarity signature, then a first electrical device may be selected at step 215 and a second electrical device may be deselected at step 220. If the received voltage waveform does not have a positive unipolar polarity signature, then a test is made at step 225 to determine whether the received voltage waveform has a negative unipolar polarity signature. If the received voltage wave does have a negative unipolar polarity signature, then the first electrical device is deselected at step 230, and the second electrical device is deselected at step 235. If the received voltage waveform does not have a negative unipolar polarity signature, then the first electrical device is selected at step 240 and the second electrical device is selected at step 245. The selected electrical device or devices, if any, are energized at step 250 by applying the received voltage waveform to any selected electrical devices. It will be clear to one skilled in the art that the method of the present invention is applicable to any number electrical devices. The example of two electrical devices described herein is presented by way of example and not by way of limitation.

It should be noted that a normal AC voltage waveform has neither a positive unipolar nor a negative unipolar signature. Indeed, a normal AC voltage waveform may be described as exhibiting a bipolar polarity signature. In the implementation described in FIG. 2, both first and second electrical devices are selected when a customary, unmodified, AC voltage waveform is received.

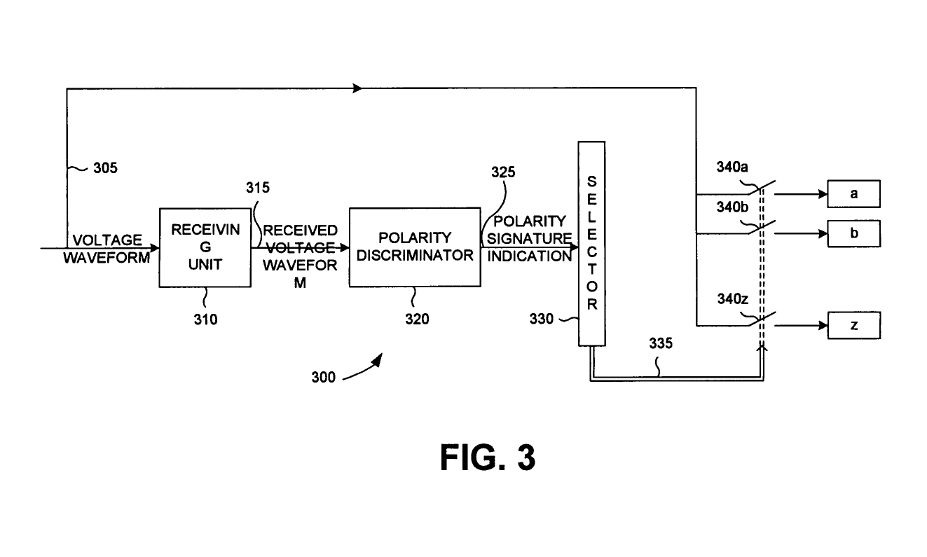

The present invention further may comprise an apparatus for selectively energizing one or more electrical devices. One embodiment 300 of such an apparatus is described in the block diagram of FIG. 3. The illustrated embodiment 300 of the apparatus comprises a receiving unit 310 that receives a voltage waveform 305 that may exhibit a polarity signature as already described. The receiving unit 310 passes a received voltage waveform 315 (that may be the same as the voltage waveform 305 in some embodiments) to a polarity discriminator 320. The polarity discriminator 320 analyzes the received voltage waveform 315 and generates a polarity signature indication 325 that is passed to a selector 330. According to the polarity signature indication 325, the selector 330 generates a control signal 335 that controls a plurality of switches 340a, 340b, . . . , 340z. Inputs to the switches are connected to the voltage waveform 305 in the illustrated embodiment. The voltage waveform 305 may be connected to one or more of electrical devices a, b, . . . , z through the action of respective switches 340a, 340b, . . . , 340z. For example, control signal 335 may cause switch 340a to close, connecting voltage waveform 305 to device a, thereby energizing device a. Control signal 335 further may cause switch 340b to close, for example, connecting voltage waveform 305 to device b, thereby energizing device b, and so on. In this way the electrical devices a, b, . . . , z may be selectively energized through the action of the selector 330 operating in accordance with the polarity signature indication 325.

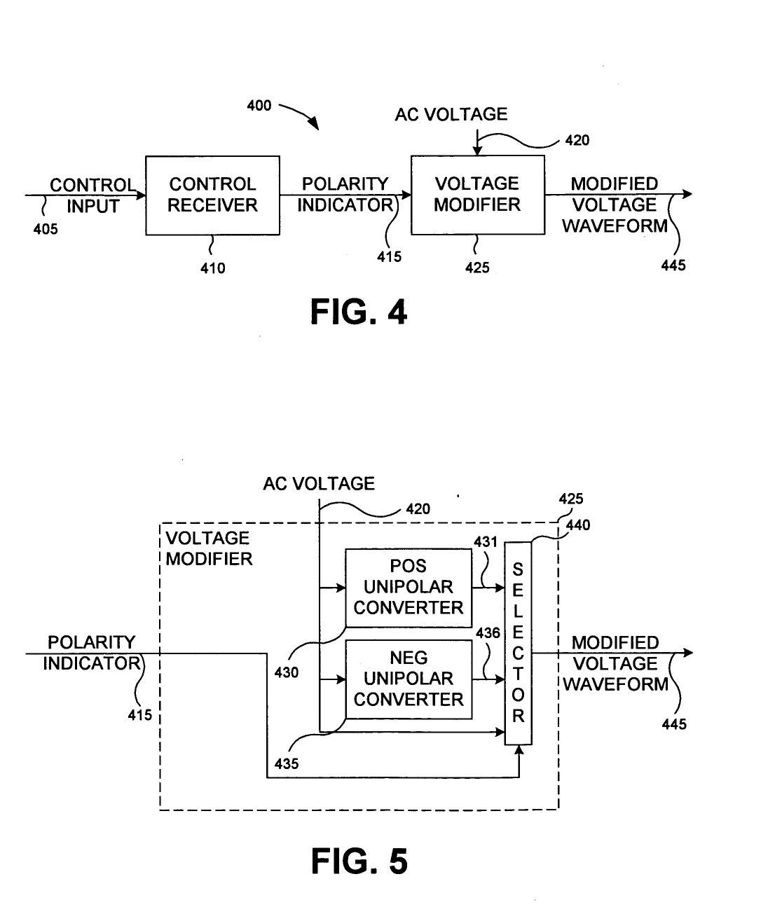

FIG. 4 is a block diagram describing an illustrative embodiment of an apparatus 400 capable of producing a voltage waveform having a polarity signature according to the present invention. The illustrated embodiment comprises a control receiver 410 that receives a control input 405. Receiving the control input 405 may take the form of, for example, detecting a position of a linear or rotary multiposition switch. In another embodiment, receiving the control input 405 may comprise receiving an electronic signal responsive to motion, a change in time of day, a presence of day lighting, an input to an electronic keypad, or the like. The control receiver 410 may generate a polarity indicator 415 according to the control input 405. The embodiment 400 further comprises a voltage modifier 425 that receives an AC powerline voltage waveform 420 and also receives polarity indicator 415. The voltage modifier 425 modifies the AC powerline voltage waveform 420 according to the polarity indicator 415, producing modified voltage waveform 445.

FIG. 5 is a block diagram of an illustrative embodiment of the voltage modifier 425 introduced in FIG. 4. This embodiment of the voltage modifier 425 comprises a positive unipolar converter 430 that receives the AC powerline voltage waveform 420 and operates on the AC powerline voltage waveform 420 to generate a positive unipolar voltage waveform 431. The embodiment of FIG. 5 further comprises a negative unipolar converter 435 that likewise receives the AC powerline voltage waveform 420 and operates on the AC powerline voltage waveform 420 to generate a negative unipolar voltage waveform 436. The positive unipolar voltage waveform 431, the negative unipolar voltage waveform 436, and an unmodified AC powerline voltage waveform 420 form respective inputs to a selector 440. The selector 440 receives the polarity indicator 415, selects one of the inputs (431, 436, 420) according to a value of the polarity indicator 415, and presents the selected input as the modified voltage waveform 445 at an output of the voltage modifier 425. It should be noted that one possible “modified” voltage waveform 445 comprises the (unmodified) AC powerline voltage waveform 420. Even in this case, the voltage waveform appearing at the output of the voltage modifier 425 is referred to a “modified” voltage waveform 445 for convenience.

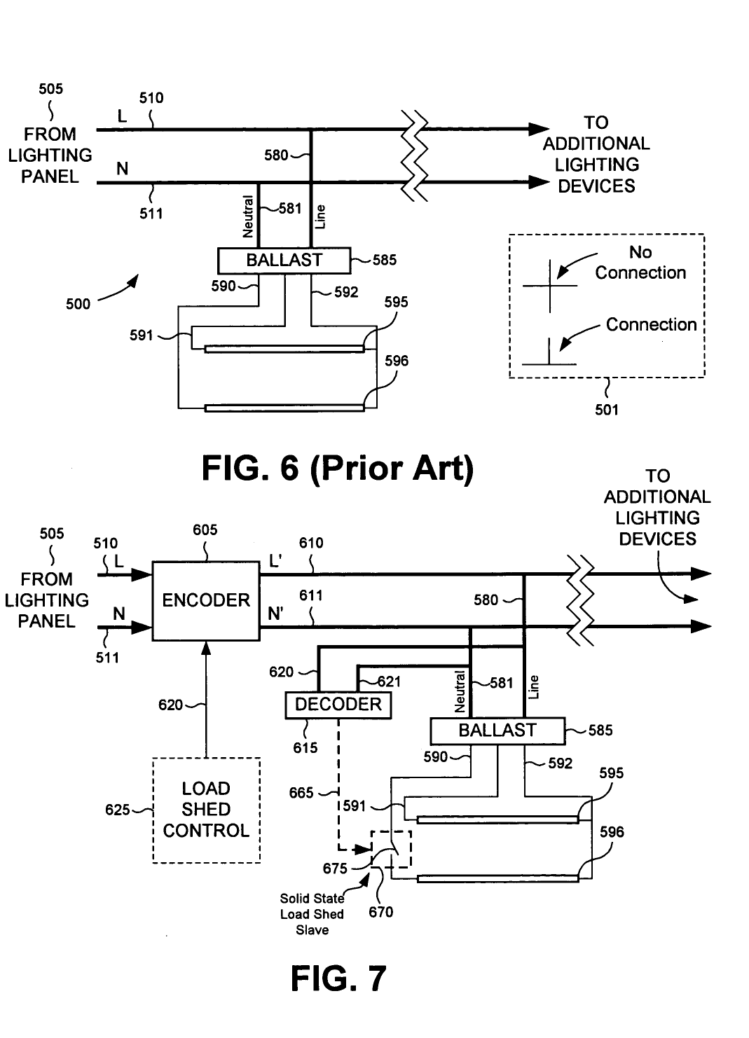

FIG. 6 is a schematic representation of a portion of a prior art fluorescent lighting installation of a type that may be found in, for example, commercial buildings. An AC powerline voltage supplied from a lighting panel 505 may power the fluorescent lighting fixture 500. In many instances, the AC powerline voltage is derived from a three-phase AC voltage source and is distributed on two power conductors, a line conductor 510 and a neutral conductor 511. Although the line conductor 510 and neutral conductor 511 typically connect in parallel to several lighting devices, e.g., fluorescent lighting fixtures, FIG. 6 illustrates only one representative fluorescent lighting fixture 500. Normally, a line conductor 580 and a neutral conductor 581 near the fluorescent lighting fixture 500 connect the respective line conductor 510 and neutral conductor 511 to a ballast (e.g., an instant start ballast) 585 that controls respective first and second fluorescent tubes 595 and 596. (Insert 501 presents a key to a wiring diagram convention employed in the present description. In particular, a four-way schematic presentation of two conductors represents no connection between the conductors; a three-way schematic presentation of two conductors indicates that the conductors are electrically connected.) The ballast 585 typically provides a momentary high voltage to terminals of fluorescent tubes 595 and 596 in order to establish a plasma arc that produces light when power is applied to the fluorescent lighting fixture 500. Subsequently, the ballast 585 limits current to first and second fluorescent tubes 595 and 596 in order to protect the tubes from damage that may result when currents in the tubes become too large. In a typical installation, conductors 590 and 591 may connect to one set of terminals of respective first and second fluorescent tubes 595 and 596. Another conductor 592 may connect to a common connection to another set of terminals on fluorescent tubes 595 and 596. It should be noted that no provision exists in the prior art fluorescent lighting fixture 500 for selectively energizing or deenergizing one of the fluorescent tubes 595 and 596.

FIG. 7 is a schematic diagram of an embodiment of an encoder/decoder structure incorporated into the prior art structure of FIG. 6 to control operation of the fluorescent lighting fixture 500 according to the present invention. As in the prior art structure illustrated in FIG. 6, lighting panel 505 supplies an AC powerline voltage on line conductor 510 with respect to neutral conductor 511. The embodiment illustrated in FIG. 7 comprises an encoder 605 interposed in the line conductor 510 and neutral conductor 511. Portions of the line conductor 510 and neutral conductor 511 lying to the right of the encoder 605 in FIG. 7 have been relabeled, and are referred to as, respectively, modified line conductor 610 and modified neutral conductor 611. It should be noted that the conductors, themselves, are not modified. Rather, voltage waveforms appearing on the conductors may be modified as described herein. The encoder 605 receives a control input 620 from load shed control 625, which may comprise, for example, a manually operated linear or rotary switch, an electronic input from a motion sensor, time of day clock, presence of day lighting, intrusion sensor, a keypad, or the like. The illustrated embodiment further comprises a decoder 615 connected to line conductor 580 and neutral conductor 581 by respective conductors 620 and 621. The illustrated embodiment still further comprises a switch 675 that may be part of a solid state load shed slave 670.

In a normal mode of operation, the switch 675 controls electrical connection of the conductor 590 to the fluorescent tube 596, thereby providing a means to energize or to deenergize the fluorescent tube 596 according to a control signal 665 that may be generated by the decoder 615. For example, switch 675 may open when control signal 665 is positive, thereby deenergizing the fluorescent tube 596. Conversely, switch 675 may close when control signal 665 is negative, thereby energizing fluorescent tube 596. In a typical lighting installation, the configuration of decoder 615, control signal 665, and switch 675 may be replicated in a plurality of similar lighting fixtures, all of which receive power from modified line conductor 610 and modified neutral conductor 611 according to the control signal 620 received by the encoder 605.

According to an exemplary mode of operation of the embodiment illustrated in FIG. 7, the control input 620 may be supplied by a user or by some type of automatic sensor, either form being represented by load shed control 625. In response to the control signal 620, the encoder 605 may generate a modified voltage waveform as described above with reference to FIGS. 4 and 5 that is distributed on modified line conductor 610 and modified neutral conductor 611 and that may be received by the decoder 615. According to the received modified voltage waveform, the decoder 615 may generate a control signal 665 that controls the switch 675 to energize or to deenergize the second fluorescent tube 596 according to the received modified voltage waveform. When the second fluorescent tube 596 is not energized, an energy saving may result, thereby contributing to a conservation of resources and to a reduced cost of operation of the lighting installation. In particular, in a facility comprising a plurality of lighting fixtures of the type illustrated in FIG. 6, modifying the installation according to the embodiment illustrated in FIG. 7 may enable the convenient deenergization of approximately 50% of the fluorescent tubes in the installation. This reduction can result in an approximate 50% reduction in the energy consumed by the installation. Such a reduction in energy may be appropriate, for example, in a supermarket during late night and early morning hours, in an office building hallway in periods when offices are not occupied, on an idle manufacturing floor, in an unoccupied restroom, and the like.

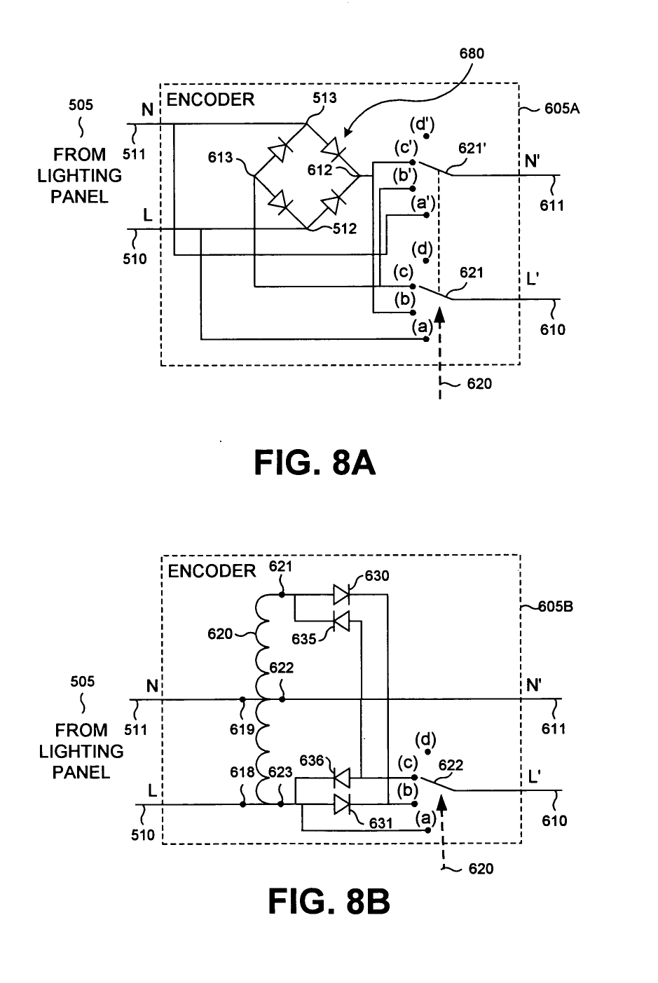

FIG. 8A is a schematic diagram of a representative embodiment of an encoder 605A that may appear, e.g., as encoder 605 in the embodiment illustrated in FIG. 7. Encoder 605A, comprising a bridge rectifier 680 and switches 621 and 621′, may receive an AC powerline voltage waveform from a lighting panel 505 on line conductor 510 and neutral conductor 511. The received AC powerline voltage waveform is applied in the illustrated embodiment to terminals 512 and 513 of the bridge rectifier 680. (The operation of the bridge rectifier 680 will be clear to one skilled in the art.) The line conductor 510 connects to input terminal 512 and the neutral conductor 511 connects to input terminal 513 of the bridge rectifier 680. Outputs from the bridge rectifier 680 are taken from terminals 612 and 613. Switches 621 (comprising terminals (a), (b), (c), and (d)) and 621′ (comprising terminals (a′), (b′), (c′), and (d′)) may operate together according to a control input 620. For example, when switch 621 makes contact with terminal (a), switch 621′ makes contact with terminal (a′) and so on for terminals (b)-(b′), (c)-(c′), and (d)-(d′). Outputs of switches 621 and 621′ connect, respectively, to modified line conductor 610 and modified neutral conductor 611. Terminal 612 of the bridge rectifier 680 connects to terminals (b) and (c′); terminal 613 of bridge rectifier 680 connects to terminals (c) and (b′). Terminal (a) connects to line conductor 510; terminal (a′) connects to neutral conductor 511. Terminals (d) and (d′) correspond to an OFF position for the switches 621 and 621′.

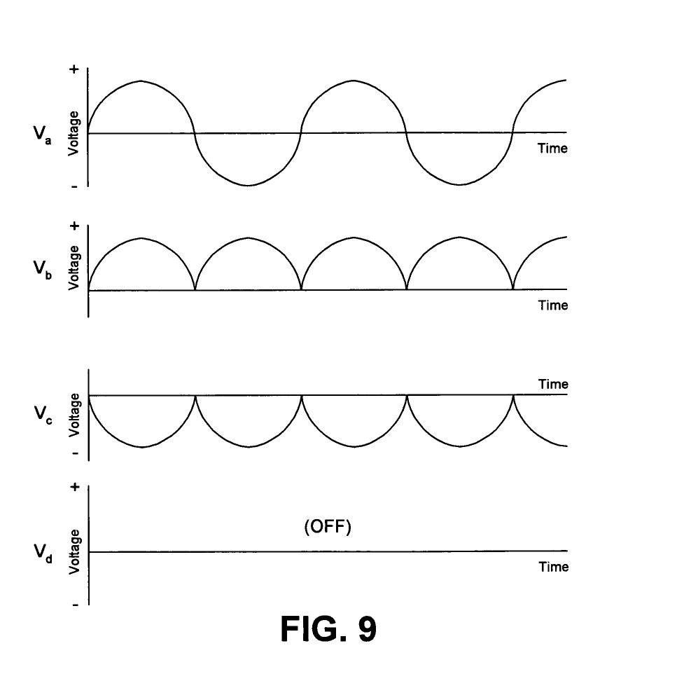

When a normal AC voltage waveform appears on line conductor 510 with respect to neutral conductor 511, operation of encoder 605A proceeds as follows. With switches 621 and 621′ in an (a)-(a′) position, the normal AC voltage waveform appears on modified line conductor 610 with respect to the modified neutral conductor 611 as illustrated by voltage waveform Vₐ in FIG. 9. The voltage waveform Vₐ may be said to exhibit a bipolar polarity signature. With switches 621 and 621′ in a (b)-(b′) position, a full-wave rectified positive pulsating direct current (DC) waveform appears on the modified line conductor 610 with respect to the modified neutral conductor 611 as illustrated by voltage waveform V_{b} in FIG. 9. The V_{b} waveform may be described as having a positive unipolar polarity signature. Similarly, a waveform having a negative unipolar polarity signature, as illustrated by voltage waveform V_{c} in FIG. 9, appears on modified line conductor 610 with respect to modified neutral conductor 611 when switches 621 and 621′ are placed in a (c)-(c′) position. When switches 621 and 621′ are placed in a (d)-(d′) position, then no waveform appears between modified line conductor 610 and modified neutral conductor 611, representing an OFF condition illustrated by zero voltage waveform V_{d} in FIG. 9.

FIG. 8B is a schematic diagram of another embodiment of an apparatus capable of performing the functions of encoder 605 shown in FIG. 7. Encoder 605B in the illustrated embodiment comprises an autotransformer 620 that connects to line conductor 510 and neutral conductor 511 with respective input terminals 618 and 619. The autotransformer 620 may comprise three outputs: a neutral output 622 that connects to modified neutral conductor 611, a first biphase output 621, and a second biphase output 623. Voltages on first and second biphase outputs 621 and 623 outputs are nominally 180° out of phase in normal operation. A diode network comprising first diode pair 630 and 631 and second diode pair 635 and 636 connect to biphase outputs 621 and 623, thereby implementing respective first and second rectifiers. The first rectifier provides a positive unipolar voltage waveform on terminal (b) (see, e.g., voltage waveform V_{b} in FIG. 9); the second rectifier provides a negative unipolar voltage waveform on terminal (c) (see, e.g., voltage waveform V_{c} in FIG. 9), the voltages being referenced to the modified neutral conductor 611. An unmodified form of the AC power line voltage comprises a bipolar voltage waveform and is presented on terminal (a) (see, e.g., voltage waveform Vₐ in FIG. 9). A selector switch 622, which may be controlled by the control input 620 (see also FIG. 7), may connect the waveform on one of terminals (a), (b), and (c) to modified line conductor 610. The encoder 605B may further comprise a fourth terminal (d) that implements an OFF condition of voltage on modified line conductor 610.

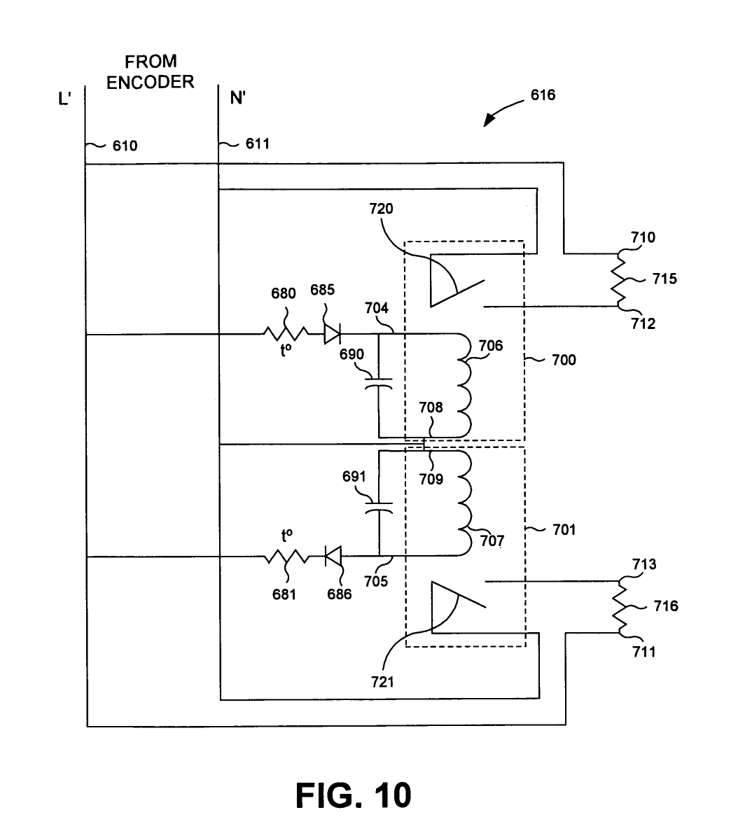

FIG. 10 is a simplified schematic diagram of an embodiment of a decoder 616 capable of selectively energizing two electrical devices 715 and 716 according to the present invention. The electrical devices 715 and 716 may comprise, for example, separate filaments of a single incandescent light bulb. Electrical device 715 has a pair of terminals 710 and 712; electrical device 716 has a similar pair of terminals 711 and 713.

The decoder 616 connects to modified line conductor 610 and modified neutral conductor 611 by means of which the decoder 616 receives a voltage waveform on modified line conductor 610 referenced to modified neutral conductor 611. The received voltage waveform may have a polarity signature generated by an encoder such as encoder 605A illustrated in FIG. 8A or encoder 605B shown in FIG. 8B. Decoder 616 further comprises a first relay 700 having a first relay coil 706 with terminals 704 and 708. First relay 700 further comprises a normally open first switch 720. Decoder 616 further may comprise a first capacitor 690 capable of smoothing a voltage waveform appearing between terminals 704 and 708 of first relay coil 706. First relay coil 706 is connected to the modified line conductor 610 through a first current-limiting component 680, e.g., a thermistor with a negative temperature coefficient, in series with a first diode 685 configured to conduct when voltage on the modified line conductor 610 is positive with respect to modified line conductor 611.

The decoder 616 further comprises a second relay 701 having a second relay coil 707 with terminals 705 and 709. Second relay 701 further comprises a normally open second switch 721. A second capacitor 691 is capable of smoothing a voltage waveform appearing across second relay coil 707. Second relay coil 707 is connected to the modified line conductor 610 through a second current-limiting component 681 in series with a second diode 686. Second diode 686 is configured to conduct when voltage on the modified line conductor 610 is negative with respect to modified neutral conductor 611.

Decoder 616 provides a means by which electrical devices 715 and 716 can be controlled according to a method of the present invention. For example, when a voltage waveform having a positive unipolar polarity signature such as V_{b} in FIG. 9 is received on the modified line conductor 610 relative to modified neutral conductor 611, first diode 685 may conduct, establishing current in first relay coil 706, and thereby causing first switch 720 to close. Closing first switch 720 connects terminals 710 and 712 of first electrical device 715 across modified line conductor 610 and modified neutral conductor 611, thereby energizing first electrical device 715. Conversely, when a positive unipolar waveform is received on the modified line conductor 610 relative to modified neutral conductor 611, second diode 686 does not conduct, so that substantially no current flows in second relay coil 707 of second relay 701, and second switch 721 does not close. Accordingly, second electrical device 716 is not energized.

When a voltage waveform having a negative unipolar polarity signature such as, for example, V_{c} in FIG. 9 is received on the modified line conductor 610 relative to modified neutral conductor 611, second diode 686 may conduct. Current is thereby establishing current in second relay coil 707, causing second switch 721 to close. Closing second switch 721 connects terminals 711 and 713 of second electrical device 716 across modified line conductor 610 and modified neutral conductor 611, thereby energizing second electrical device 716. First diode 685 does not conduct in this case, first switch 720 does not close, and first electrical device 715 is not energized.

When a voltage waveform having a bipolar polarity signature such as, for example, Vₐ in FIG. 9 is received on the modified line conductor 610 relative to modified neutral conductor 611, both first and second diodes 685 and 686 may conduct on alternate half-cycles of the bipolar waveform. Current therefore is established in both first and second relay coils 706 and 707, closing both first and second switches 720 and 721. Both first and second electrical devices 715 and 716 are thereby energized.

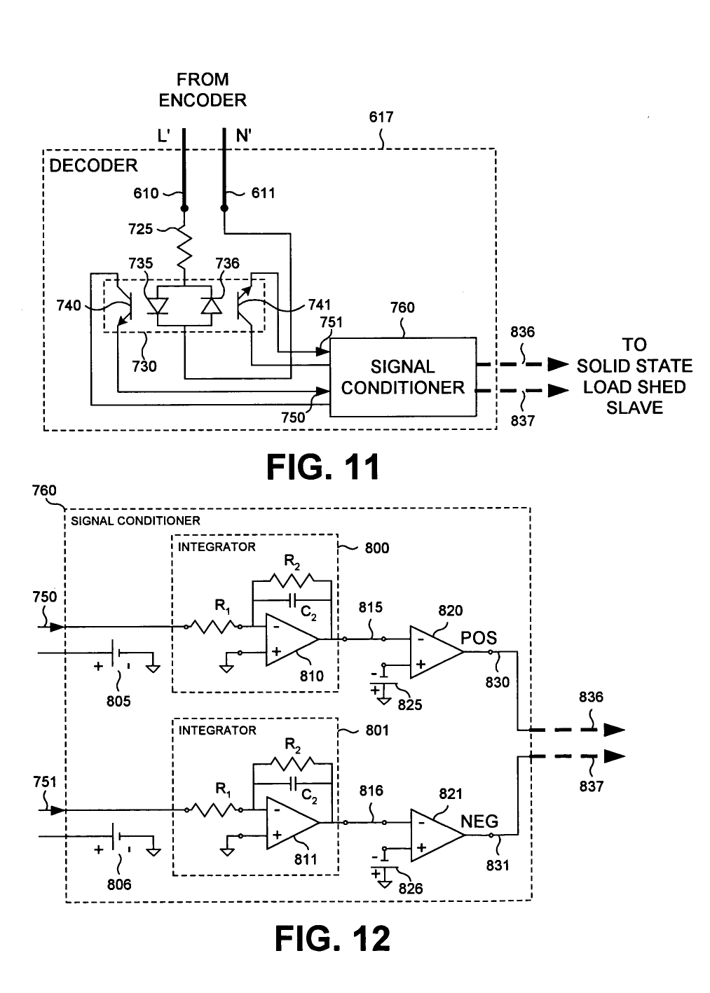

FIG. 11 is a schematic diagram of another embodiment of a decoder 617 that may be employed, for example, as decoder 615 in FIG. 7. The decoder 617 is connected electrically to modified line conductor 610 and modified neutral conductor 611 between which is connected an optoisolator 730. In the illustrated embodiment, a first diode input to the optoisolator 730 is connected across modified line conductor 610 and modified neutral conductor 611 through a current-limiting resistor 725. During time intervals when voltage at modified line conductor 610 is positive with respect to modified neutral conductor 611, current may flow in first diode 735, thereby causing light to be emitted by first diode 735. Light emitted by first diode 735 may be collected by a first transistor 740, thereby reducing an impedance of first transistor 740 and enabling a current 750 that can be sensed by signal conditioning circuitry 760. Similarly, a second diode input to the optoisolator 730 may likewise be connected across modified line conductor 610 and modified neutral conductor 611 in parallel with first diode 735. At times when voltage at modified line conductor 610 is negative with respect to modified neutral conductor 611, current may flow in second diode 736, causing second diode 736 to emit light. The emitted light may be collected by a second transistor 741, thereby enabling a current 751 that also can be sensed by the signal conditioning circuitry 760 in like manner to the sensing of current 750. According to a representative embodiment, the signal conditioning circuitry 760 may assert control signals 836 and 837 according to a polarity signature of a received voltage waveform on modified line conductor 610 with respect to modified neutral conductor 611. The polarity signature of the received voltage waveform is represented by the currents 750 and 751 as described herein.

FIG. 12 is a simplified schematic diagram of an embodiment of signal conditioning circuitry 760 introduced in FIG. 11. The illustrated embodiment comprises first and second integrators 800 and 801 that may be implemented with resistor-capacitor networks connected to first and second operational amplifiers 810 and 811. The embodiment further comprises first and second voltage sources 805 and 806 and first and second comparators 820 and 821. Voltage source 805 connects to first transistor 740 (FIG. 11) and produces current 750 when first transistor 740 is in a low-impedance state. Similarly, voltage source 806 connects to second transistor 741 (FIG. 11) and produces current 751 when second transistor 741 is in a low-impedance state.

The embodiment of first integrator 800 is based upon a first operational amplifier 810 configured with an input resistor R₁ connected to a negative input terminal of first operational amplifier 810 and to a parallel combination of resistor R₂ and capacitor C₂ in a negative feedback path of first operational amplifier 810. A positive input terminal of first operational amplifier 810 is grounded. As is well understood in the art, when values of R₂ and C₂ are chosen such that a product R₂×C₂ is large relative to a period of the input current 750, this configuration can comprise a leaky integrator. The leaky integrator may act to produce an output voltage 815 that approximates a short-term average value (within a constant of proportionality) of the input current 750. More particularly, when the input current 750 has a positive average value, the output voltage 815 is negative due to an inverting property of the operational amplifier 810.

The output voltage 815 in the illustrated embodiment is applied to a negative input terminal of comparator 820, which may have a small negative voltage 825 applied to a positive input terminal thereof. The action of the comparator 820 produces an output voltage 830 (POS) that assumes a positive logic value when the output voltage 815 is less (that is, more negative) than the small negative voltage 825. When the output voltage 815 is greater than the small negative voltage 825, (e.g., approximately zero) the output voltage 830 (POS) assumes a negative logic value. In this sense, comparator 820 converts the output voltage 815 (an analog signal) to a first logic signal, POS, that can assume either a positive or a negative binary logic value. The combination of first integrator 800, first voltage source 805, and first comparator 820 comprises a first detector that generates first logic signal, POS, in response to a voltage waveform having a positive unipolar polarity signature.

In a similar manner, another output voltage 831 (NEG) is generated in response to input current 751 through the action of integrator 801, second voltage source 806, and comparator 821. The output voltage 831 (NEG) assumes a positive logic value when the value of output signal 816 is less than (i.e., more negative than) a small negative voltage 826 applied to a positive input terminal of comparator 821. NEG assumes a negative logic value otherwise. As with the first detector described above, the combination of second integrator 801, second voltage source 806, and first comparator 821 comprises a second detector that generates a second logic signal, NEG, in response to a voltage waveform having a negative unipolar polarity signature.

As an example of operation of the signal conditioner circuit 760, assume, for example, that a received voltage waveform having a positive unipolar polarity signature appears on modified line conductor 610 with respect to modified neutral conductor 611 at the input to the decoder illustrated in FIG. 11. In this situation, diode 735 may conduct, emitting light that may be collected by first transistor 740, thereby causing first transistor 740 to assume a low impedance state. Voltage source 805 (FIG. 12) may generate a positive current 750 entering integrator 800 and resulting in a negative voltage 815 at the output of integrator 800. The magnitude of voltage 815 is approximately proportional to an average value of the current 750. The voltage 815 also may be less (i.e. more negative) than the small negative voltage 825. Accordingly, POS, the output voltage 830 of comparator 820, assumes a positive logic value. Because a voltage waveform having a positive unipolar polarity signature appears on modified line conductor 610 with respect to modified neutral conductor 611, diode 736 does not conduct and does not emit light. Second transistor 741, therefore, assumes a high impedance state, and voltage source 806 does not produce a measurable current 751 at the input of integrator 801. A nominally zero value of output voltage 816 from second integrator 801 results. Because of the small negative voltage 826 applied to the positive input terminal of comparator 821, NEG, the output voltage 831 of second comparator 821, assumes a negative logic value.

A similar analysis concludes that presentation of a voltage waveform having a negative unipolar polarity signature on modified line conductor 610 with respect to modified neutral conductor 611 causes NEG, the output voltage 831 of second comparator 821, to assume a positive logic value. At the same time, POS, the output voltage 830 of first comparator 820 assumes a negative logic value.

Output voltages 830 and 831 may be presented as respective control signals 836 and 837. According to an illustrative implementation, a positive control signal 836 may cause switch 675 (FIG. 7) to open, thereby deenergizing fluorescent tube 596.

As another example of operation of the signal conditioner circuit 760, a received voltage waveform having a bipolar polarity signature may be presented at the input to the decoder 617 of FIG. 11 on modified line conductor 610 relative to modified neutral conductor 611, causing both diodes 735 and 736 to conduct. That is, diode 735 conducts during periods when the received waveform is positive, and diode 736 conducts during periods when the received waveform is negative. The action of transistors 740 and 741 in conjunction with voltage sources 805 and 806 produces pulsating positive currents 750 and 751 that are integrated by respective integrators 800 and 801 to produce negative output voltages 815 and 816. Comparators 820 and 821 convert these negative voltages to positive logic values, POS and NEG appearing as output voltages 830 and 831. Output voltages 830 and 831 may comprise respective control signals 836 and 837 that may be used to control a plurality of electrical devices according to methods described herein.

In view of the foregoing, it will be understood by those skilled in the art that the methods of the present invention can facilitate conservation of energy in lighting installations, particularly in lighting installations that employ fluorescent fixtures. The above-described embodiments have been provided by way of example, and the present invention is not limited to these examples. Multiple variations and modification to the disclosed embodiments will occur, to the extent not mutually exclusive, to those skilled in the art upon consideration of the foregoing description. For example, lighting fixtures that comprise more than two fluorescent tubes may be used, and a plurality of fluorescent tubes may be controlled in various flexible modes by circuitry similar to that described in the embodiment of FIGS. 10-12. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A method of operating at least two electrical devices, comprising:
receiving a voltage waveform having a polarity signature, the voltage waveform operable to energize the at least two electrical devices;
detecting the polarity signature of the received voltage waveform;
generating a control signal based on the polarity signature of the voltage waveform; and
energizing the at least two electrical devices according to the control signal.

2. The method as set forth in claim 1, wherein the detecting comprises recognizing a polarity signature selected from a group consisting of a positive unipolar polarity signature, a negative unipolar polarity signature, and a bipolar polarity signature.

3. The method as set forth in claim 1, wherein energizing the at least two electrical devices further comprises positioning switching circuitry to energize/de-energize individual electrical devices based on the control signal.

4. The method as set forth in claim 3, wherein the polarity signature changes in response to a load shedding command.

5. The method as set forth in claim 3, wherein the energizing comprises:
energizing a first electrical device when the recognized polarity signature is one of a positive unipolar polarity signature, a negative polarity signature, and a bipolar polarity signature; and
deenergizing a second electrical device when the recognized polarity signature is another of a positive unipolar polarity signature, a negative unipolar polarity signature, and a bipolar polarity signature.

6. The method of claim 1, further comprising:
receiving a control input;
receiving an alternating current voltage waveform; and
modifying the alternating current voltage according to the control input to produce a voltage waveform having one of a positive unipolar polarity signature, a negative polarity signature, and a bipolar polarity signature.

7. The method as set forth in claim 6, wherein the receiving of a control input comprises at least one of detecting a position of a multiposition switch, receiving a signal representing a load-shedding command, receiving a signal responsive to motion, receiving a signal indicative of a change in time of day, receiving a signal indicative of a presence of day lighting, and receiving a signal from an electronic keypad.

8. An apparatus for operating electrical devices, the apparatus comprising:
a receiving unit capable of receiving a voltage waveform having a polarity signature; and
a polarity discriminator capable of recognizing a polarity signature in the received voltage waveform and of generating a polarity signature indication according to the recognized polarity signature; and
a selector operable to generate a control signal based on the recognized polarity signature, the control signal operable to configure switching circuitry to selectively energize/de-energize electrical devices.

9. The apparatus as set forth in claim 8, wherein the polarity discriminator is capable of recognizing a polarity signature selected from a group consisting of a positive unipolar polarity signature, a negative unipolar polarity signature, and a bipolar polarity signature.

10. The apparatus as set forth in claim 8, wherein the switching circuitry is operable to energize the electrical device using the voltage waveform.

11. The apparatus as set forth in claim 10, wherein the switching circuitry is operable to deenergize the electrical devices according to the control signal.

12. The apparatus as set forth in claim 8, further comprising:
a control receiver capable of receiving a control input and of generating a polarity indicator according to the control input; and
a voltage modifier capable of receiving an alternating current voltage waveform and of modifying the alternating current voltage to produce a voltage waveform having one of a plurality of polarity signatures.

13. The apparatus as set forth in claim 12, wherein the plurality of polarity signatures comprises:
positive unipolar polarity signature;
a negative polarity signature; and
a bipolar polarity signature.

14. The apparatus as set forth in claim 12 wherein the control receiver is capable of receiving at least one of a position of a multiposition switch, a signal representing a load-shedding command, a signal responsive to motion, a signal responsive to a change in time of day, a signal indicative of a presence of day lighting, and a signal from an electronic keypad.

15. A load-shedding mechanism adaptable to electrical wiring supplying power to a plurality of electrical devices, the mechanism comprising:
a decoder connected to the electrical wiring and adapted to receive a voltage waveform having a polarity signature and further adapted to generate a control signal according to the polarity signature, wherein the received voltage waveform energizes at least one of the plurality of electrical devices; and
at least one switch adapted to deenergize at least one of the plurality of electrical devices according to the control signal.

16. The load-shedding mechanism as set forth in claim 15, further comprising an encoder capable of producing a voltage waveform having a polarity signature according to a control input.

17. The load-shedding mechanism as set forth in claim 16, wherein the control input comprises at least one of a position of a multiposition switch, a signal responsive to a load-shedding command, a signal responsive to motion, a signal responsive to a change in time of day, receiving a signal indicative of a presence of day lighting, and receiving a signal from an electronic keypad.

18. The load-shedding mechanism as set forth in claim 15, wherein the encoder comprises:
first line and neutral conductors capable of receiving an alternating current voltage waveform;
a first rectifier adapted to modify the alternating current voltage waveform to produce a positive unipolar voltage waveform; and
a selector switch responsive to the control input, the selector switch being capable of connecting one of the alternating current voltage waveform and the positive unipolar voltage waveform to second line and neutral conductors.

19. The load-shedding mechanism as set forth in claim 18, wherein:
the encoder further comprises a second rectifier adapted to modify the alternating current voltage waveform to produce a negative unipolar voltage waveform; and
the selector switch further is capable of connecting the negative unipolar voltage waveform to the second line and neutral conductors.

20. A method comprising:
receiving via a power line, a voltage waveform having a polarity signature, the voltage waveform operable to energize a plurality of gas discharge lamps;
detecting the polarity signature of the received voltage waveform;
generating a control signal based on the polarity signature of the voltage waveform;
positioning switching circuitry based on the control signal, the switching circuitry operable to couple the power line and the plurality of gas discharge lamps; and
energizing, via the switching circuitry, the plurality of gas discharge lamps according to the control signal.

21. The method of communication of claim 20 further characterized by; including a source of AC power, a rectifying means connected to said source of AC power and a switching means being connected to said source of AC power and the output of said rectifying means, the output of said switching means connected to said power line such that said switching means can be adjusted to supply a voltage waveform comprising continuous AC power, a pulsating or continuous positive DC power or a pulsating or continuous negative DC power to said power line.
